(19) United States
(12) Patent Application Publication
(10) Pub. No.: US 2017/0333161 A1
(43) Pub. Date: Nov. 23, 2017

(54) ENGAGEABLE ORTHODONTIC ALIGNER APPLIANCE

(71) Applicant: CLEARCORRECT OPERATING, LLC, Round Rock, TX (US)

(72) Inventor: Paul Doan DINH, Round Rock, TX (US)

(73) Assignee: CLEARCORRECT OPERATING, LLC, Round Rock, TX (US)

(21) Appl. No.: 15/600,263

(22) Filed: May 19, 2017

Related U.S. Application Data
(60) Provisional application No. 62/339,522, filed on May 20, 2016.

(51) Int. Cl. A61C 7/08; A61C 7/14; A61C 13/15

(52) U.S. Cl. CPC A61C 7/08; A61C 7/14; A61C 19/003

(57) ABSTRACT

A dual-purpose aligner which can serve as both an engager template and an aligning appliance includes is used for treating a patient according to a predetermined orthodontic treatment plan. The dual-purpose aligner can be seated on the teeth of the patient as an engager template having an engager void which is filled with a predetermined composite for bonding to a tooth of a patient. The engager template aligns the engager void with a corresponding tooth. A light-curing process cures the predetermined composite in the engager void through the dual-purpose aligner appliance to fabricate the engager and attach the engager to the corresponding tooth. The dual-purpose aligner can also be seated on the teeth of the patient as an aligner appliance for moving the teeth of the patient from a first position to a second position according to the predetermined orthodontic treatment plan.

### CROSS-REFERENCE TO RELATED APPLICATION

This application claims the benefit of U.S. Provisional Application No. 62/339,522, filed May 20, 2016.

### FIELD OF THE DISCLOSURE

This application relates generally to orthodontic dental appliances, and more particularly to improvements in the fitting the orthodontic treatment appliances with a minimum of hardware. To this end, the present disclosure provides a dual-purpose, orthodontic aligner appliance that functions as both an engager template and as an aligner appliance.

### BACKGROUND

An aligner is a tightly fitting polyurethane appliance used to reposition one or more of a patient's teeth over a predetermined amount of time based on a treatment plan. The field of aligners has advanced from the early days of positioners to much more complex designs with more capability for advanced tooth movements. For example, aligners correct conditions including crowded teeth, spacing between teeth, overbites, underbites, and rotated teeth. A treatment plan includes straightening teeth using a series of clear, custom-made, removable aligners that gradually move teeth in small incriments. The treatment plan may also include the use of engagers to improve the effectiveness of the aligners.

Engagers placed on one or more teeth of a patient can further assist the aligner in moving the patient's teeth, Engagers are typically a composite material bonded to a tooth to allow for added retention of the aligner on the tooth. Currently, to use engagers for a treatment plan a doctor must do two things. First, doctors must create an engager template using a separate tray that is thermoformed over a model with a material that is different from that used to fabricate aligners. The engager template is typically thinner and less durable than the aligner and can be discarded after use. Second, the doctor must create a separate aligner appliance. Aligners tend to be more durable because they are fabricated from a different, stronger material, as the aligner appliance serves to move one or more teeth based on the orthodontic treatment plan.

Techniques for installing the engager template on the patient's teeth can include cutting sections of the engager template so that only sections including an engager void remain, which can allow for easier removal, but also damages the engager template. Using separate materials for fabricating the engager templates and the aligners, in addition to the engager templates being damaged and/or discarded, creates excess waste, increased cost, and additional labor. Additionally, using a separate engager template and aligner appliance reduces stress on the patient as only one procedure is required to install the engagers rather than the extra step of using a separate engager template. If the aligners themselves are used as a template to create the engagers (i.e., if the aligner also serves as the engager template), then the overall orthodontic treatment process is simplified.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

According to embodiments of the disclosed subject matter, a dual-purpose aligner can serve as both an engager template and an aligner appliance. When used as an engager template, at least one engager void on the dual-purpose aligner is aligned with a corresponding tooth and filled with a predetermined composite for bonding to a tooth of a patient. A light curing process polymerizes the composite in the engager void to create and attach the engager to the corresponding tooth. When used as an aligner appliance, the dual-purpose aligner is seated on the teeth of the patient according to a predetermined orthodontic treatment plan and used to move the patient's teeth.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 depicts a perspective view of an exemplary dual-purpose aligner appliance according to one or more aspects of the disclosed subject matter;

FIG. 2 depicts a workflow of using the dual-purpose aligner appliance of FIG. 1 according to one or more embodiments of the disclosed subject matter; and

FIG. 3 depicts a perspective view of a direction of a removal technique of the dual-purpose aligner appliance according to one or more aspects of the disclosed subject matter.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed subject matter. However, it will be apparent to those skilled in the art that embodiments may be practiced without these specific details. In some instances, well-known structures and components may be shown in block diagram form in order to avoid obscuring the concepts of the disclosed subject matter.

Referring now to the drawings, wherein like reference numerals designate identical or corresponding parts throughout the several views:

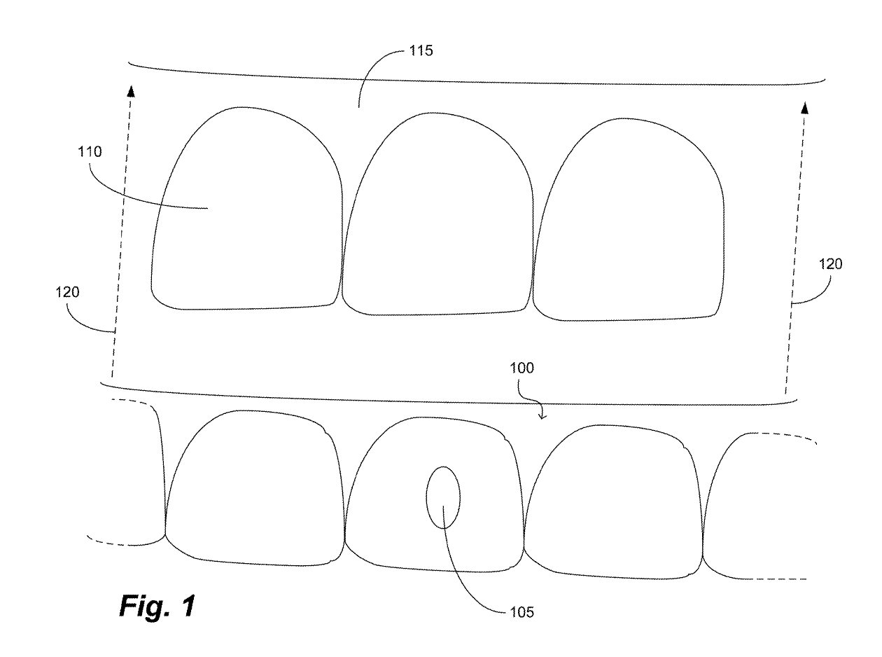

FIG. 1 depicts a perspective view of an exemplary dual-purpose aligner appliance 100 (hereby referred to as appliance 100) according to one or more aspects of the disclosed subject matter. The appliance 100 is a dual-purpose aligner which serves as both an engager template and an aligner appliance. An engager template can be used to place one or more engagers on one or more corresponding teeth in a predetermined position for each of the one or more teeth based on an orthodontic treatment plan. The engager can be a composite-resin material, for example, attached to the tooth, thereby allowing the aligner appliance to interact with the tooth via the extension provided by the engager. The aligner appliance can be used to move one or more teeth from a first position to a second position, respectively, for each of the one or more teeth. Often times the engager can assist the aligner appliance in moving a tooth to which the engager is attached by acting as a handle or some type of leverage mechanism, as it may be possible that some teeth are shaped or positioned in a way that can be difficult for an aligner appliance alone to move and reposition the teeth.

The dual-purpose aligner appliance 100 includes an engager void 105 filled with a predetermined composite so that an engager can be positioned to be attached to a corresponding tooth by light-curing the predetermined composite in the engager void 105 to harden the predetermined composite as well as attach the predetermined composite to the tooth. In other words, the engager void 105 is used to position the engager. After the engager is positioned, the engager void 105 is used to assist in the positioning of the teeth with engagers attached by allowing the aligner to interact with the tooth that the aligner may have had difficulty interacting with when no engager was attached. The appliance 100 is seated in direction 120 on a patient's teeth 110 and gums 115 by installing the appliance 100 over the gums 115 of the patient. The appliance 100, when acting as an engager template, positions and/or aligns the engager void 105 in a predetermined location on the corresponding tooth 110. Depending upon the treatment plan a number of teeth 110 may require an engager, and therefore, a corresponding number of engager voids 105 can be included in the appliance 100.

In one aspect, prior to seating the appliance 100 on the patient's teeth 110 and gums 115, the engager void can be filled with a composite-resin material, which is a synthetic resin commonly composed of Bis-GMA and other dimethacrylate monomers (e.g., TEGMA, UDMA, HDDMA), a filler material such as silica, and a photoinitiator. Dimethylglyoxime is also commonly added to achieve certain physical properties such as flowability. The composite-resin material is typically composed of a two-thirds paste-type composite and a one-third flowable composite as would be known by one of ordinary skill in the art. In another aspect, the engager void 105 can be filled with a prefabricated engager. The prefabricated engager can be of a pre-formed, self-aligning elastomeric property material which adheres to each of the one or more teeth to be adjusted. The self-aligning elastomeric property material can include one of silicone, latex rubber, poly-urethanes, and combinations thereof Further, the self-aligning elastomeric property material can be manufactured by a molding technique or a prefabrication technique.

Additionally, the dual-purpose aligner appliance 100 can be seated, and then later removed, without using a separating agent, such as petroleum jelly. A separating agent can be for casting and modeling used in conjunction with plaster, cement, resins, metals, ceramics, and the like. For the appliance 100, use of a separating agent is not necessary because the predetermined composite used with the engager template does not bond to the appliance 100, as the appliance 100 is made of polyurethane as opposed to co-polyester, which is typically used to fabricate stand-alone engager templates. Therefore, the separating agent can be removed from the treatment plan materials, thereby saving time and money.

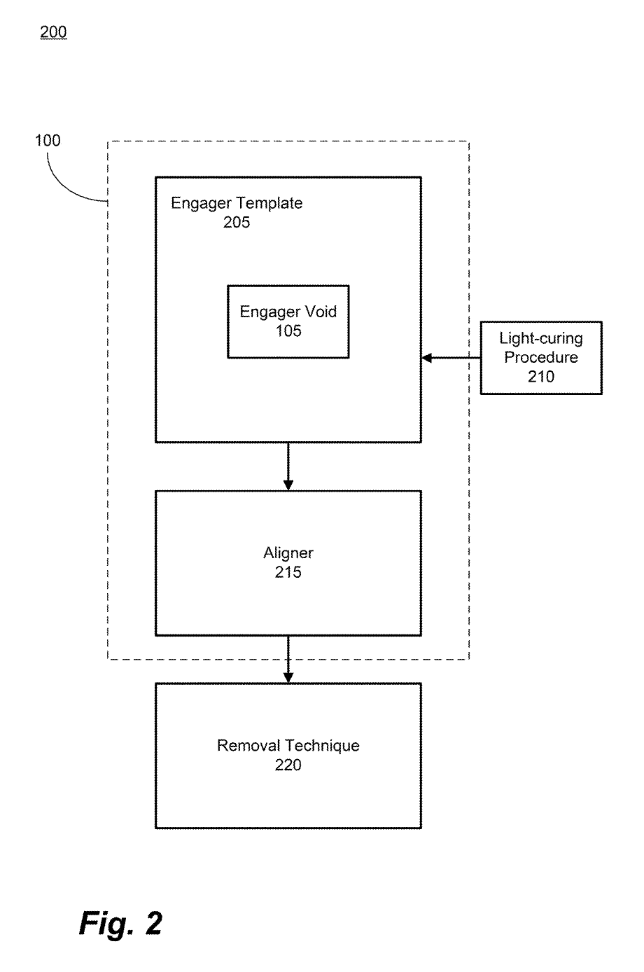

FIG. 2 depicts a workflow 200 of a sample application using the dual-purpose aligner appliance 100 according to one or more embodiments of the disclosed subject matter. The workflow 200 can include the dual-purpose aligner appliance 100 serving as an engager template 205 or an aligner appliance 215, and a removal technique 220 of the appliance 100.

The engager template 205 can include the engager void 105, which can be positioned in a predetermined location on the corresponding tooth 110. Additionally, one or more predetermined areas of the engager template, corresponding to the position of the one or more engager voids 105, can be subject to a light-curing procedure 210 used for attaching an engager to the patient's teeth 110. The light-curing procedure 210 can polymerize resin-based composites, such as the composite-resin material used to fill the engager void 105. A dental curing light, such as a tungsten halogen light, a light-emitting diode, a plasma arc, or a laser can be used to cure the composite-resin material. In one aspect, the light-curing procedure 210 can create the engager by polymerization of the composite-resin stored in the engager void 105, as well as attach the engager to the corresponding tooth 110. In another aspect, a prefabricated engager positioned in the engager void 105 can be attached to the corresponding tooth 110 via the light-curing procedure 210.

After each of the one or more engagers has been secured to each corresponding tooth 110, the aligner appliance 215 can be used to implement the orthodontic treatment plan by moving one or more teeth 110 from a first position to a second position, respectively, for each of the one or more teeth 110.

Accordingly, the dual-purpose aligner appliance 100 can serve as both the engager template 205 and the aligner appliance 215. Using the dual-purpose aligner appliance 100 not only reduces the amount of materials needed for the orthodontic treatment plan, but, at the same time, reduces the time spent on fabricating the engager template 205 and aligner appliance 215, and the like, as the creation of separate engager templates 205 is no longer necessary.

The removal technique 220 can include a predetermined removal technique for removing the dual-purpose aligner appliance 100 as explained in greater detail below, applicable both when the dual-purpose aligner appliance 100 serves as the engager template 205 or the aligner appliance 215.

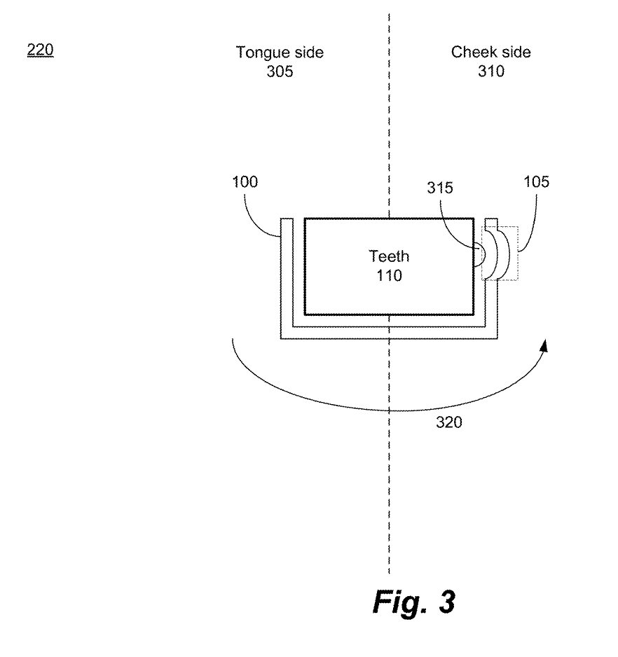

FIG. 3 depicts a perspective view of a direction of a removal technique 220 of the dual-purpose aligner appliance 100 according to one or more aspects of the disclosed subject matter.

The appliance 100 can be seated on the teeth 110 with the engager void 105 in communication with an engager 315. To remove the appliance 100 from the seated position on the teeth 110 of the patient, the appliance 100 can be removed in a direction 320. The direction 320 corresponds to removing the appliance 100 from a tongue side 305 of the teeth 110 to a cheek side 310 of the teeth 110. In one aspect, the direction 320 is curved or arced, indicating that the removal technique 220 does not occur in a linear fashion. Such removal technique 220 can be utilized any time the appliance 100 is removed. Therefore, the removal technique 220 can be utilized when the appliance 100 is serving as the engager template 205 or the aligner appliance 215.

The dual-purpose aligner appliance 100 offers several advantages including, but not limited to, reducing waste, cost, and time, thereby improving orthodontic treatment plans. For example, because the engager template 205 is not discarded after use, but rather, is usable as an aligner appliance, materials and time can be saved. Further, traditionally, engager templates are made from a thinner, more delicate material, which causes them to break, thereby adding to the waste. But because the appliance 100 is configured to be a dual-purpose aligner, such appliance 100 uses a more durable material for both the engager template and aligning aspects.

Another advantage of the dual-purpose aligner appliance 100 can be that the appliance does not require a separating agent for the engager template 205 or the aligner appliance 215. Further, costs can be reduced as new engager templates, and, in turn, new engagers do not need to be created for each step of the treatment plan, as engager templates are not discarded after step of the treatment plan.

Reference throughout the specification to “one embodiment” or “an embodiment” means that a particular feature, structure, characteristic, operation, or function described in connection with an embodiment is included in at least one embodiment of the disclosed subject matter. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments. Further, it is intended that embodiments of the disclosed subject matter can and do cover modifications and variations of the described embodiments.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the disclosed subject matter to any particular orientation or configuration. Furthermore, terms such as “first,” “second,” “third,” etc., merely identify one of a number of portions, components, points of reference, operations and/or functions as described herein, and likewise do not necessarily limit embodiments of the disclosed subject matter to any particular configuration or orientation.

Having now described embodiments of the disclosed subject matter, it should be apparent to those skilled in the art that the foregoing is merely illustrative and not limiting, having been presented by way of example only. Thus, although particular configurations have been discussed herein, other configurations can also be employed. Numerous modifications and other embodiments (e.g., combinations, rearrangements, etc.) are enabled by the present disclosure and are within the scope of one of ordinary skill in the art and are contemplated as falling within the scope of the disclosed subject matter and any equivalents thereto. Features of the disclosed embodiments can he combined, rearranged, omitted, etc., within the scope of the invention to produce additional embodiments. Furthermore, certain features may sometimes be used to advantage without a corresponding use of other features. Accordingly, Applicant(s) intend(s) to embrace all such alternatives, modifications, equivalents, and variations that are within the spirit and scope of the disclosed subject matter.

1. A dual-purpose aligner appliance, comprising:
an engager template for aligning an engager void with a tooth of a patient; and
an aligner for moving at least one tooth of a patient from a first position to a second position according to a predetermined orthodontic treatment plan,
wherein the engager void is filled with a predetermined composite for creating an engager used for assisting the aligner in moving the at least one tooth,
wherein the dual-purpose aligner appliance can be seated on the at least one tooth as the engager template for fabricating the engager, and
wherein the dual-purpose aligner appliance can be seated on the at least one tooth as the aligner for moving the at least one tooth according to the predetermined orthodontic treatment plan.

2. The dual-purpose aligner appliance of claim 1, wherein the dual-purpose aligner appliance is removed from the at least one tooth in a predetermined direction.

3. The dual-purpose aligner appliance of claim 2, wherein the predetermined direction corresponds to a direction from a side adjacent to a tongue of the patient toward a side adjacent to a cheek of the patient.

4. The dual-purpose aligner appliance of claim 1, wherein the predetermined composite is a two-thirds paste-type composite and a one-third flowable-type composite.

5. The dual-purpose aligner appliance of claim 1, wherein the predetermined composite is a prefabricated engager.

6. The dual-purpose aligner appliance of claim 5, wherein the engager void can be filled with the prefabricated engager.

7. The dual-purpose aligner appliance of claim 1, wherein a light curing process polymerizes the predetermined composite for creating the engager.

8. A method of treating a patient according to a predetermined orthodontic treatment plan using a dual-purpose aligner appliance, comprising:
seating the dual-purpose aligner appliance on at least one tooth of a patient as an engager template for aligning an engager void with a corresponding tooth, wherein the engager void is filled with a predetermined composite;
applying a light-curing process to the predetermined composite in the engager void for creating an engager and attaching the engager to the corresponding tooth; and
seating the dual-purpose aligner appliance on the at least one tooth of the patient as an aligner for moving the at least one tooth from a first position to a second position according to the predetermined orthodontic treatment plan.

9. The method of claim 8, further comprising:
removing the dual-purpose aligner appliance from the at least one tooth in a predetermined direction.

10. The method of claim 9, wherein the predetermined removal direction corresponds to a direction from a side adjacent to a tongue of the patient toward a side adjacent to a cheek of the patient.

11. The method of claim 8, wherein the predetermined composite is a two-thirds paste-type composite and a one-third flowable-type composite.

12. The dual-purpose aligner appliance of claim 8, wherein the predetermined composite is a prefabricated engager.

13. The method of claim 12, wherein the engager void can be filled with the pre-fabricated engager.

14. The method of claim 8, wherein the dual-purpose aligner appliance is seated without a separating agent.

15. The method of claim 8, wherein the light-curing process polymerizes the predetermined composite for creating the engager.
